(19) United States
(12) Patent Application Publication
(10) Pub. No.: US 2023/0219408 A1
(43) Pub. Date: Jul. 13, 2023

(54) FUEL TANK FILL ASSEMBLY

(71) Applicant: STANT USA CORP., Connersville, IN (US)

(72) Inventor: Paul C. WETZEL, Oxford, OH (US)

(21) Appl. No.: 18/009,159

(22) PCT Filed: Jun. 24, 2021
(86) PCT No.: PCT/US2021/038928

§ 371 Date: Dec. 8, 2022

Related U.S. Application Data
(60) Provisional application No. 63/043,449, filed on Jun. 24, 2020.

(51) Int. Cl. B60K 15/04

(52) U.S. Cl. CPC B60K 15/04; B60K 2015/0461

(57) ABSTRACT

The fuel storage system includes a fuel tank fill assembly and a fuel tank. The fuel tank fill assembly is configured to conduct fuel to the fuel tank from a fuel-dispensing nozzle and may include corrosion-resistant components. The fuel tank stores the fuel for later use by an engine included in the vehicle.

### PRIORITY CLAIM

This application claims priority to U.S. Provisional Application Ser. No. 63/043,449 filed Jun. 24, 2020, which is incorporated by reference herein.

### BACKGROUND

The present disclosure relates to a fuel tank fill assembly. More particularly, the present disclosure relates to a fuel tank fill assembly for a vehicle fuel tank.

### SUMMARY

A fuel tank fill assembly is adapted to conduct fuel from a fuel-dispensing nozzle to a fuel tank. The fuel tank fill assembly includes a fuel filler pipe shaped to define a passageway that carries fuel to the fuel tank and a closure unit mounted to the fuel filler pipe. The closure unit is configured to selectively close an inlet of the passageway.

In the illustrative embodiments, the fuel filler pipe is a single-piece component comprising stainless steel materials suited to avoid rust and corrosion. The single-piece fuel filler pipe is shaped to define a filler tube, a filler head, and filler pipe neck. The filler tube is configured to be coupled to the fuel tank to deliver fuel to the fuel tank. The filler head is configured to mount the closure unit and is sized to receive the fuel-dispensing nozzle. The filler pipe neck extends from the filler tube to the filler head at a neck transition angle relative to the filler tube.

In illustrative embodiments, the fuel filler pipe has a laser-weld seam along the length of the passageway. The laser-weld seam is configured to resist degradation during the useful life of the fuel filler pipe that might lead to unwanted leakage of fuel vapor from the passageway through the seam.

In the illustrative embodiments, the filler tube has a first inner diameter. The first inner diameter of the filler tube is less than a second inner diameter of the filler head while being sized to manage stiffness of the fuel tank filler neck and avoid degradation of the stainless steel material wall or the laser-weld seam that might lead to unwanted fuel vapor leakage.

In the illustrative embodiments, the first inner diameter of the filler tube is less than the second inner diameter of the filler head so as to create the venturi effect within the passageway to suction the fuel toward the fuel tank during refueling. A venturi effect is created when there is sufficient flow (based on standard fuel dispensing) travelling through a tube with a small diameter. This creates the vacuum that entrains the air from outside the filler neck and does not allow the vapor to escape. If the tube is too big, this venturi effect will not occur. The ratio of the first inner diameter to the second inner diameter creates a venturi effect within the passageway.

In the illustrative embodiments, the filler head of the fuel filler pipe is shaped to define a fill cup, a closure unit mount, and a filler head transition portion. The fill cup has the second inner diameter and extends from the filler pipe neck. The closure unit mount is configured to receive the closure unit. The filler head transition portion extends from the fill cup to the closure unit mount at a transition angle relative to the fill cup.

In the illustrative embodiments, the closure unit mount has a third inner diameter. The third diameter is greater than the second inner diameter of the fill cup while being sized to manage stiffness of the fuel tank filler neck and avoid degradation of the stainless steel material wall or the laser-weld seam that might lead to unwanted fuel vapor leakage.

In illustrative embodiments, the fuel filler pipe is manufactured via a specialized method adapted to avoid degradation of pipe materials that might lead to unwanted fuel vapor leakage. In some embodiments, the method may include rolling a sheet of select stainless steel material to the filler tube first diameter and laser welding a seam along a length of the pipe.

These and other features of the present disclosure will become more apparent from the following description of the illustrative embodiments.

### BRIEF DESCRIPTION OF THE DRAWINGS

FIG. 1 is a perspective view of a fuel storage system that includes a fuel tank and a fuel tank fill assembly configured to conduct fuel to the fuel tank from a fuel-dispensing nozzle and showing that the fuel tank fill assembly includes a single-piece fuel filler pipe shaped to define a passageway configured to carry fuel toward the fuel tank and a closure unit mounted to the single-piece fuel filler pipe to selectively close off the passageway;

FIG. 2 is a perspective view of a portion of the fuel tank fill assembly of FIG. 1 showing the single-piece fuel filler pipe is shaped to define a filler tube configured to be coupled to the fuel tank, a filler head configured to receive and mount the closure unit, and a filler pipe neck that extends between the filler tube and the filler head;

FIG. 3 is an exploded view of the portion of the fuel tank fill assembly of FIG. 2 showing the filler head is shaped to define a fill cup that extends from the filler pipe neck, a closure unit mount that is configured to receive the closure unit, and a filler head transition portion that extends between the fill cup and the closure unit mount;

FIG. 4 is a cross-section of the single-piece fuel filler pipe taken along line 4-4 including in the portion of the fuel tank fill assembly of FIG. 2 showing the filler tube has a first inner diameter, the fill cup has a second inner diameter that is greater than the first inner diameter, and the closure unit mount has a third inner diameter that is greater than the second inner diameter;

FIG. 5 is a detail view of FIG. 4 showing the filler head transition portion extends from the fill cup to the closure unit mount at a transition angle;

FIG. 6 is a detail view of FIG. 5 showing the filler pipe neck extends from the filler tube to the fill cup of the filler head at a neck transition angle;

FIG. 7 is a diagrammatic view of a method of forming the fuel tank fill assembly showing the method includes a six-stage ram expansion process using a expansion machine to form the fuel filler pipe;

FIG. 8 is an elevation view of a tool used in the expansion machine in FIG. 7 to form the shape of the fuel filler pipe;

FIG. 9 is an elevation and diagrammatic view of the expansion progression of the fuel filler pipe;

FIG. 10 is a perspective view of another single-piece filler pipe similar to the fuel filler pipe of FIGS. 1-9, the second fuel filler pipe shaped to define a filler tube configured to be coupled to the fuel tank, a filler head configured to receive and mount the closure unit, and a filler pipe neck that extends between the filler tube and the filler head;

FIG. 11 is a cross-section of the fuel filler pipe taken along line 11-11 including in the portion of the fuel tank fill assembly of FIG. 10 showing the filler tube has a first inner diameter, the fill cup has a second inner diameter that is greater than the first inner diameter, and the closure unit mount has a third inner diameter that is greater than the second inner diameter, and showing the first, second, and third inner diameters are smaller compared to the fuel filler pipe of FIGS. 1-9;

FIG. 12 is a detail view of FIG. 11 showing the closure unit mount is shaped to include a mount body and a flange extends from the mount body perpendicular to the mount body;

FIG. 13 is a perspective view of another single-piece filler pipe similar to the fuel filler pipe of FIGS. 1-9, the third fuel filler pipe shaped to define a filler tube configured to be coupled to the fuel tank, a filler head configured to receive and mount the closure unit, and a filler pipe neck that extends between the filler tube and the filler head;

FIG. 14 is a cross-section of the fuel filler pipe taken along line 11-11 including in the portion of the fuel tank fill assembly of FIG. 10 showing the filler tube has a first inner diameter, the fill cup has a second inner diameter that is greater than the first inner diameter, and the closure unit mount has a third inner diameter that is greater than the second inner diameter, and showing the first, second, and third inner diameters are larger compared to the fuel filler pipe of FIGS. 1-9; and

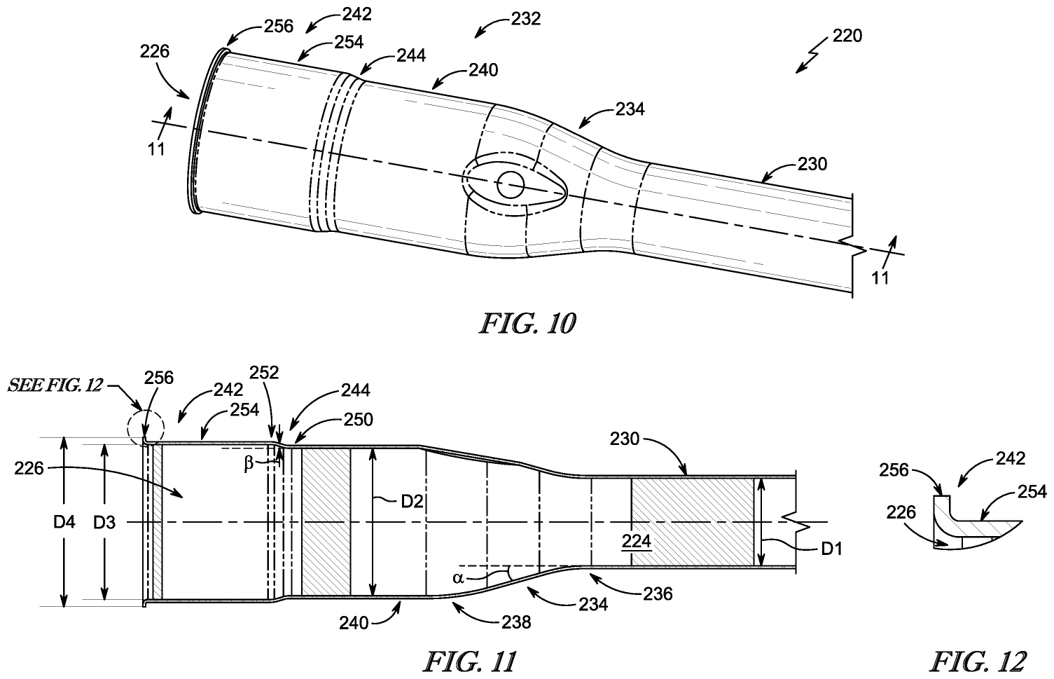

FIG. 12 is a detail view of FIG. 11 showing the closure unit mount is shaped to include a mount body and a flange extends from the mount body at an angle relative to the mount body.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

A fuel storage system 10 adapted to receive and store liquid fuel for use in a vehicle is shown in FIG. 1. The fuel storage system 10 includes a fuel tank fill assembly 12 and a fuel tank 14 as shown in FIG. 1. The fuel tank fill assembly 12 is configured to conduct fuel to the fuel tank 14 from a fuel-dispensing nozzle (not shown). The fuel tank 14 stores the fuel for later use by an engine included in the vehicle. In some embodiments, the fuel storage system 10 may further include a filler hose 16 that is illustratively flexible and interconnects the fuel tank fill assembly 12 to the fuel tank 14.

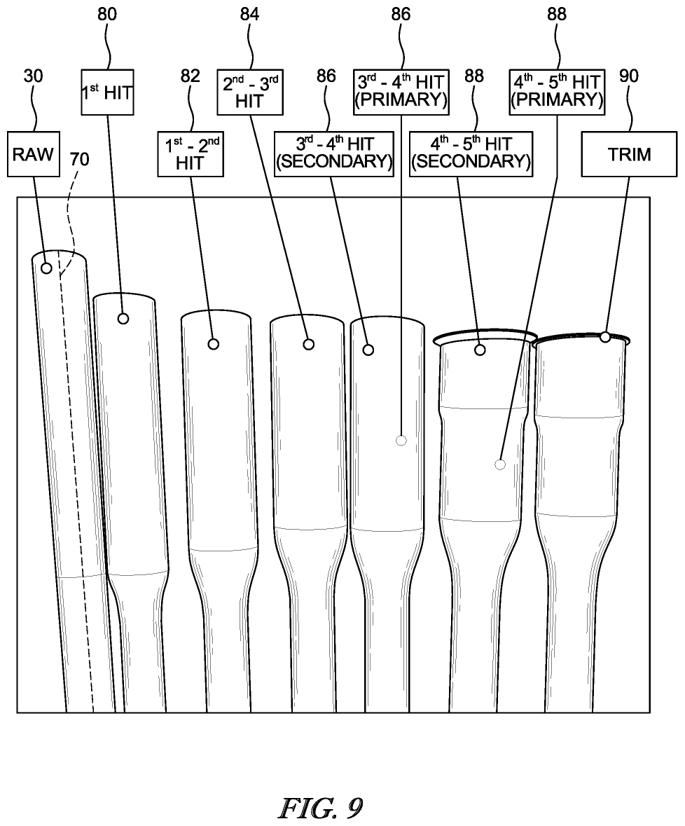

The fuel tank fill assembly 12 includes a fuel filler pipe 20 and a closure unit 22 as shown in FIGS. 1-9. The fuel filler pipe 20 is shaped to define a passageway 24 configured to carry fuel to the fuel tank 14. The closure unit 22 is mounted to the fuel filler pipe 20 and configured to selectively close an inlet 26 of the passageway 24. The closure unit 22 is a capless closure in the illustrative embodiment.

As the fuel filler pipe 20 carries fuel to the fuel tank 14, the fuel filler pipe 20 is prone to corrosion or rusting. As such, the fuel filler pipe 20 comprises stainless steel materials. In some embodiments, fuel filler pipes may include a filler tube and a separately formed fuel filler head comprising stainless steel materials welded to the filler tube, making it easier to expand the stainless steel materials for mounting the closure unit 22. However, welding the fuel filler head to the filler tube increases possible leak paths in the fuel filler pipe. The weld between the fuel filler head and the filler tube also creates a heat affected zone (HAZ) that increases corrosion.

Therefore, the fuel filler pipe 20 is formed from stainless steel materials as a single-piece component as shown in FIG. 1. The single-piece fuel filler pipe 20 eliminates the weld and reduces the overall cost of the fuel filler pipe 20. Additionally, as the single-piece fuel filler pipe 20 may be entirely formed from stainless steel, reducing the chance or corrosion or rusting.

In the illustrative embodiment, the stainless steel material of the fuel filler pipe 20 may be 304 stainless steel, 304L stainless steel, 436 stainless steel, and/or 436L stainless steel. The 304 stainless steel has a carbon content of about, or precisely 0.08%. The 304L stainless steel has a carbon content of about, or precisely 0.03%. The 436 stainless steel has a carbon content of about, or precisely 0.12%. The 304L stainless steel has a carbon content of about, or precisely 0.03%. Therefore, the carbon content of the stainless steel materials that form the fuel filler pipe 20 may be between about, or precisely 0.03% and 0.12%.

Even still, forming the fuel filler pipe 20 as a single-piece component from stainless steel materials present challenges. In typical fuel filler pipes, the fuel filler head is formed separately so that the stainless steel may be expanded to mount the closure unit 22, while the filler tube is kept a smaller diameter. A venturi effect is created when there is sufficient flow (based on standard fuel dispensing) travelling through a tube with a small diameter. This creates the vacuum that entrains the air from outside the filler neck and does not allow the vapor to escape.

If the tube is too big, this venturi effect will not occur. However, deep drawing a portion of the fuel filler pipe 20 from such a small inner diameter tube to be able to mount the closure unit 22 presents challenges because of the properties of stainless steel.

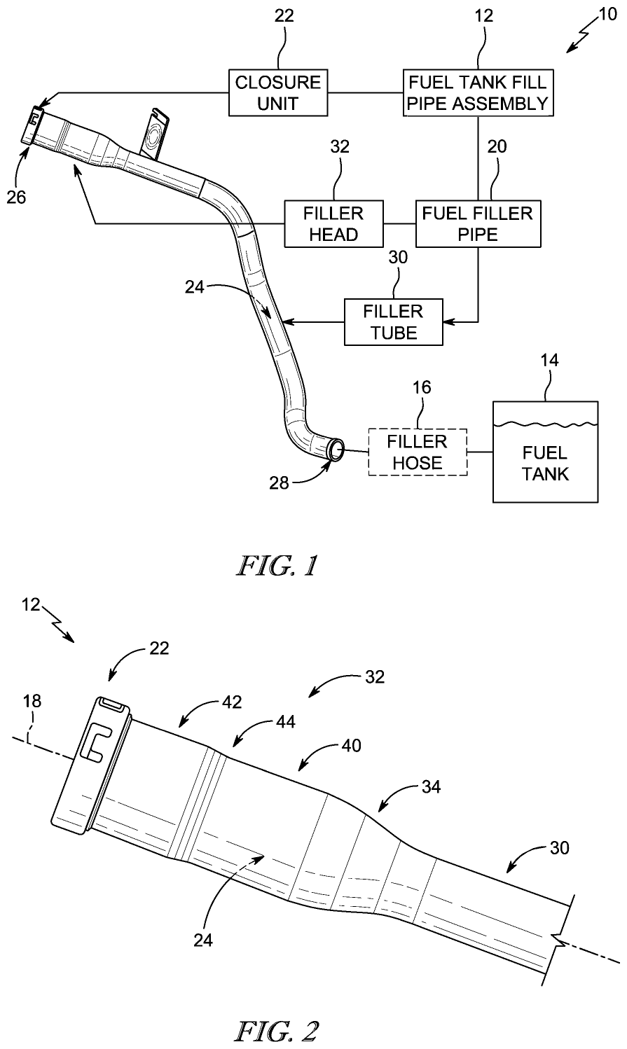

To form the fuel filler pipe 20 as a single-piece component from stainless steel materials, the fuel filler pipe 20 is shaped to define a filler tube 30, a filler head 32, and a filler pipe neck 34 as shown in FIGS. 2-6. The filler tube 30 is configured to be coupled to the fuel tank 14 to deliver fuel to the fuel tank 14. The filler head 32 is configured to mount the closure unit 22 and sized to receive the fuel-dispensing nozzle. The filler pipe neck 34 extends from the filler tube 30 to the filler head 32 at a neck transition angle α relative to the filler tube 30. In the illustrative embodiment, the filler head 32 is concentric with at least a portion of the filler tube 30 and extends along an axis 18 as shown in FIGS. 2-6.

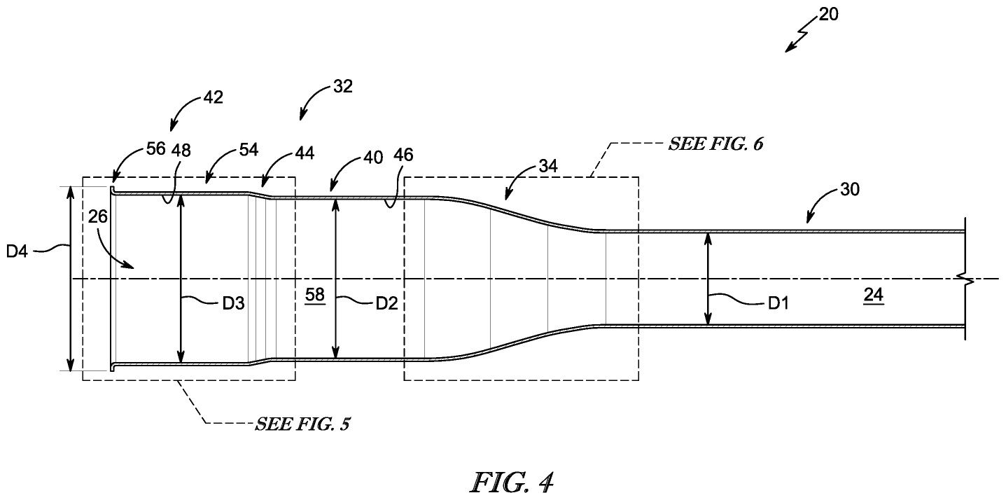

The filler tube 30 has a first inner diameter D1, while the filler head 32 has a second inner diameter D2 as shown in FIGS. 4-6. The first inner diameter D1 of the filler tube 30 is less than the second inner diameter D2 of the filler head 32 so as to create the venturi effect within the passageway 24 to suction the fuel toward the fuel tank 14 during refueling.

The smaller inner diameter D1 of the filler tube 30 accelerates the fuel through the filler tube 30 resulting in a drop in pressure across the filler pipe neck 34. As such, the pressure in the filler tube 30 is lower than the pressure in filler head 32 and the fuel tank 14. The higher pressure in the filler head 32 accelerates the fuel through the filler tube 30 suctioning the fuel into the fuel tank 14.

A ratio of the first inner diameter D1 of the filler tube 30 to the second inner diameter D2 of the filler head 32 may be between about, or precisely, 0.49-0.60 in some embodiments. In other embodiments, the ratio of the first inner diameter D1 of the filler tube 30 to the second inner diameter D2 of the filler head 32 may be between about, or precisely, 0.50-0.59.

In some embodiments, the ratio of the first inner diameter D1 of the filler tube 30 to the second inner diameter D2 of the filler head 32 may be between about, or precisely, 0.49-0.55. In other embodiments, the ratio of the first inner diameter D1 of the filler tube 30 to the second inner diameter D2 of the filler head 32 may be between about, or precisely, 0.55-0.60.

In other embodiments, the ratio of the first inner diameter D1 of the filler tube 30 and the second inner diameter D2 of the filler head 32 is about, or precisely, 0.59. In the illustrative embodiment, the ratio of the first inner diameter D1 of the filler tube 30 and the second inner diameter D2 of the filler head 32 is about, or precisely, 0.50.

In the illustrative embodiment, the first inner diameter D1 of the filler tube 30 may be about, or precisely, 27 millimeters. The filler tube 30 may be expanded to the second diameter D2 between about, or precisely, 68% and 103% of the first diameter D1. In other embodiments, the tube 30 is expanded between about, or precisely, 68% and 71%. In other embodiments, the tube 30 is expanded between about, or precisely, 100% and 103%.

The filler pipe neck 34 is shaped to define a first fillet 36 at the interface with the filler tube 30 and a second fillet 38 at the interface with the filler head 32 as shown in FIG. 6. The filler pipe neck 34 extends between the filler tube 30 and the filler head 32 at the neck transition angle α so as to follow the natural material flow.

The neck transition angle α may be between about, or precisely, 7 degrees and 15 degrees in some embodiments. In other embodiments, the neck transition angle α may be between about, or precisely, 10 degrees and 15 degrees. In some embodiments, the neck transition angle α may be between about, or precisely, 10.5 degrees and 14.8 degrees.

In other embodiments, the neck transition angle α is about, or precisely 10.5 degrees. In the illustrative embodiments, the neck transition angle α is about, or precisely 14.8 degrees.

The filler head 32 of the fuel filler pipe 20 is shaped to define a fill cup 40, a closure unit mount 42, and a filler head transition portion 44 as shown in FIGS. 2-6. The fill cup 40 has the second inner diameter D2 and extends from the filler pipe neck 34. The closure unit mount 42 is configured to receive the closure unit 22. The filler head transition portion 44 extends from the fill cup 40 to the closure unit mount 42 at a transition angle β relative to the fill cup 40.

The closure unit mount 42 has a third inner diameter D3 that is greater than the second inner diameter D2 of the fill cup 40. The second inner diameter D2 of the fill cup 40 is sized so that an inner seal 64 of the closure unit 22 engages an inner surface 46 of the fill cup 40. The third inner diameter D3 of the closure unit mount 42 is sized so that an outer seal 66 of the closure unit 22 engages an inner surface 48 of the closure unit mount 42.

A ratio of the first inner diameter D1 of the filler tube 30 to the third inner diameter D3 of the closure unit mount 42 may be between about, or precisely, 0.47-0.57 in some embodiments. In other embodiments, the ratio of the first inner diameter D1 of the filler tube 30 to the third inner diameter D3 of the closure unit mount 42 may be between about, or precisely, 0.48-0.56.

In some embodiments, the ratio of the first inner diameter D1 of the filler tube 30 to the third inner diameter D3 of the closure unit mount 42 may be between about, or precisely, 0.48-0.52. In other embodiments, the ratio of the first inner diameter D1 of the filler tube 30 to the third inner diameter D3 of the closure unit mount 42 may be between about, or precisely, 0.52-0.56.

In other embodiments, the ratio of the first inner diameter D1 of the filler tube 30 to the third inner diameter D3 of the closure unit mount 42 may be about, or precisely, 0.56. In the illustrative embodiment, the ratio of the first inner diameter D1 of the filler tube 30 and the third inner diameter D3 of the closure unit mount 42 is about, or precisely, 0.48.

In other words, to form the closure unit mount 42 of the filler head 32, the filler tube 30 is further expanded to the third diameter D3 of the fill cup 40. The filler tube 30 is expanded between about, or precisely, 78% and 110% of the first diameter D1 to form the closure unit mount 42. In other embodiments, the filler tube 30 is expanded between about, or precisely, 78%-80% of the first diameter D1 to form the closure unit mount 42. In other embodiments, the filler tube 30 is expanded between about, or precisely, 108%-110% of the first diameter D1 to form the closure unit mount 42.

A ratio of the second inner diameter D2 of the fill cup 40 and the third inner diameter D3 of the closure unit mount 41 may be between about, or precisely, 0.94-0.97 in some embodiments. In other embodiments, the ratio of the second inner diameter D2 of the fill cup 40 and the third inner diameter D3 of the closure unit mount 41 may be between about, or precisely, 0.95-0.96. In the illustrative embodiment, the ratio of the second inner diameter D2 of the fill cup 40 and the third inner diameter D3 of the closure unit mount 42 is about, or precisely, 0.96.

In other words, to form the closure mount unit 42, the fill cup 40 is expanded between about, or precisely 2.7% and 7% of the second diameter D2. In some embodiments, the fill cup 40 is expanded between about, or precisely, 3%-7% of the second diameter D2. In other embodiments, the fill cup 40 is expanded between about, or precisely, 2.7%-4.6% of the second diameter D2.

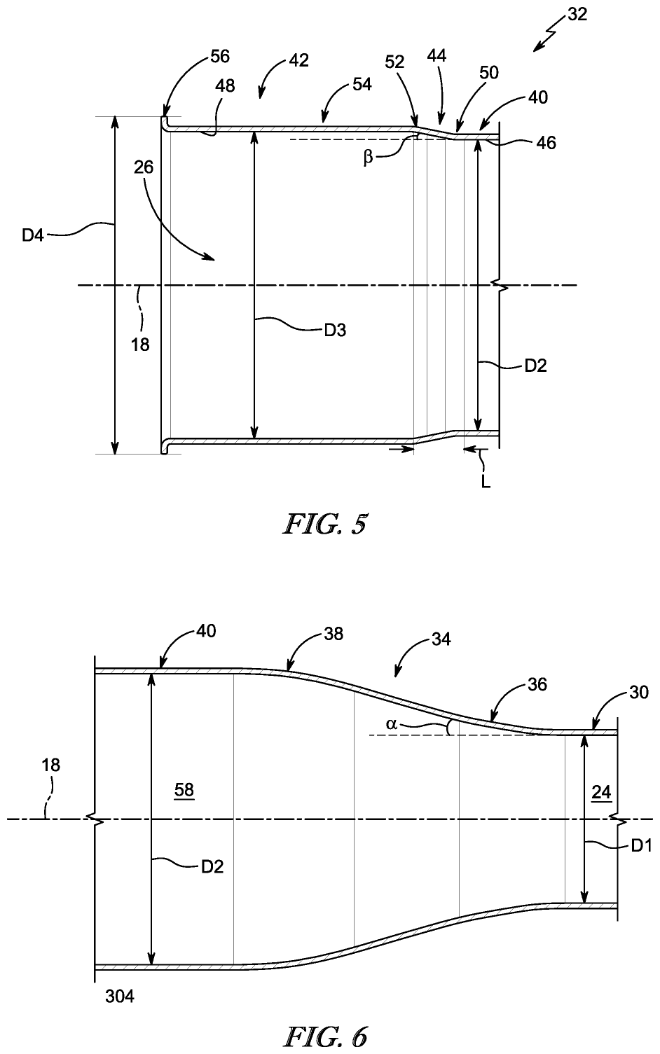

The filler head transition portion 44 is shaped to define a first fillet 50 at the interface with the fill cup 40 and a second fillet 52 at the interface with the closure unit mount 42 as shown in FIG. 5. The filler head transition portion 44 extends a length L between fill cup 40 and the closure unit mount 42.

The filler head transition portion 44 allows the closure unit 22 to be latched into position with minimal axial translation. The filler head transition portion 44 also ensures compression force on seals 64, 66 is radial and not axial so that there is a low insertion force to prevent rolled capless seals of the capless assembly.

The transition angle β may be between about, or precisely, 5 degrees and 10 degrees in some embodiments. In other embodiments, the transition angle β may be between about, or precisely, 6 degrees and 9 degrees.

In other embodiments, the transition angle β is about, or precisely 5.7 degrees. In the illustrative embodiment, the transition angle β is about, or precisely 9.3 degrees.

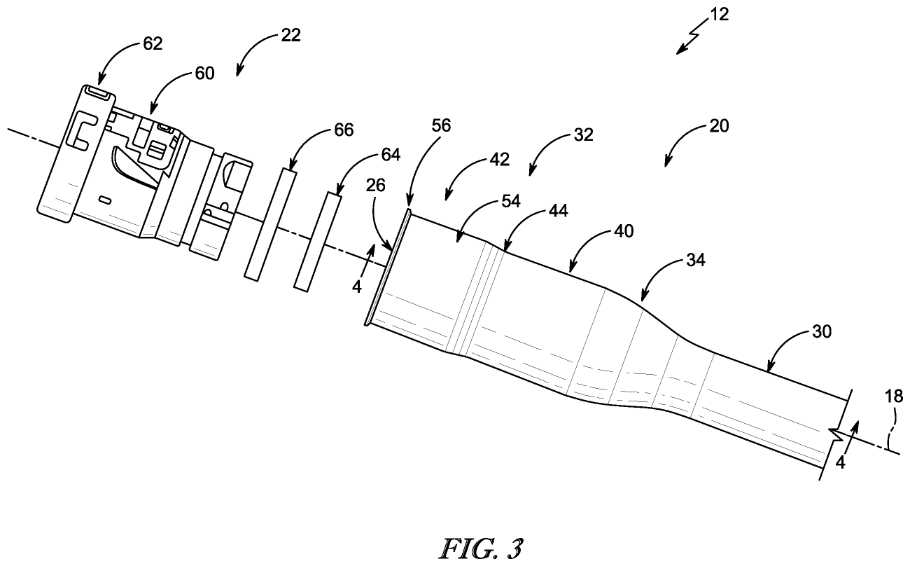

The closure unit mount 42 is shaped to define a mount body 54 and a flange 56 as shown in FIGS. 3-5. The mount body 54 has the third inner diameter D3 and extends from the filler head transition portion 44. The flange 56 extends from the mount body 54 and is configured to allow the secure latching of the closure unit 22.

The flange 56 has a fourth diameter D4 as shown in FIGS. 4 and 5. The fourth diameter D4 is greater than the third inner diameter D3 of the mount body 54.

A ratio of the first inner diameter D1 of the filler tube 30 and the fourth diameter D4 of the flange 56 may be between about, or precisely, 0.43-0.52 in some embodiments. In other embodiments, the ratio of the first inner diameter D1 of the filler tube 30 and the fourth diameter D4 of the flange 56 may be between about, or precisely, 0.44-0.51.

In some embodiments, the ratio of the first inner diameter D1 of the filler tube 30 and the fourth diameter D4 of the flange 56 may be between about, or precisely, 0.43-0.47. In other embodiments, the ratio of the first inner diameter D1 of the filler tube 30 and the fourth diameter D4 of the flange 56 may be between about, or precisely, 0.47-0.52.

In other embodiments, the ratio of the first inner diameter D1 of the filler tube 30 and the fourth diameter D4 of the flange 56 may be about, or precisely, 0.51. In the illustrative embodiment, the ratio of the first inner diameter D1 of the filler tube 30 to the forth diameter of the flange 56 is about, or precisely, 0.44.

A ratio of the third inner diameter D3 of the mount body 54 and the fourth diameter D4 of the flange 56 may be between about, or precisely, 0.90-0.93 in some embodiments. In other embodiments, the ratio of the third inner diameter D3 of the mount body 54 and the fourth diameter D4 of the flange 56 may be between about, or precisely, 0.91-0.92. In the illustrative embodiment, the ratio of the third inner diameter D3 of the mount body 54 to the forth diameter D4 of the flange 56 is about, or precisely, 0.92.

In other words, to form the flange 56, the mount body 54 is expanded further to the fourth diameter D4. In some embodiments, the closure unit mount 42 is expanded between about, or precisely 6% and 11.4% of the third diameter D3. In other embodiments, the closure unit mount 42 is expanded between about, or precisely, 7.2%-10.9% of the third diameter D3. In other embodiments, the closure unit mount 42 is expanded between about, or precisely, 6.6%-9.7% of the third diameter D3.

Turning again to the closure unit 22, the closure unit 22 is a capless closure 22 that includes a closure unit body 60 and an outer dust cover 62 as shown in FIG. 3. The capless closure unit 22 may also include an inner closure door (not shown) that pivots relative to the closure unit body 60 to allow entry of the fuel-dispensing nozzle into a nozzle-receiving space 58 of the fill cup 40 which is larger than the passageway 24. In some embodiments, the closure unit 22 may be a compact capless closure unit 22 or a universal capless closure unit 22.

The third inner diameter D3 of the closure unit mount 42 of the filler head 32 is sized to receive the closure unit body 60. The closure unit body 60 is inserted into the inlet 26 of the filler head 32 so that the seals 64, 66 engage the surfaces 46, 48. The flange 56 of the closure unit mount 42 allows the closure unit body 60 to be secured to the filler head 32.

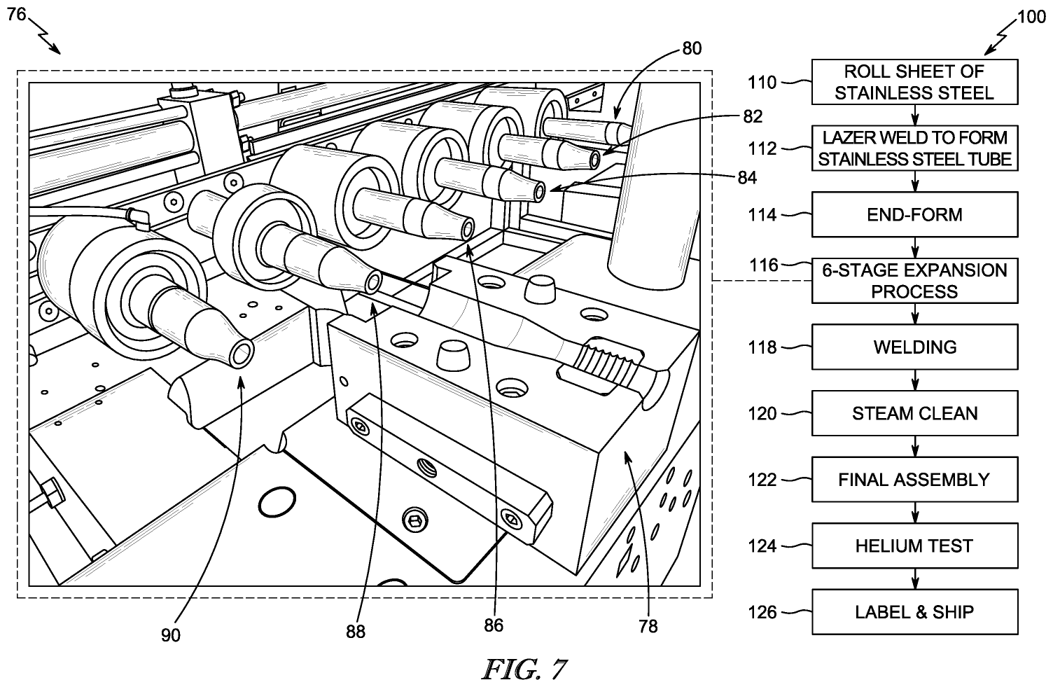

A method 100 of forming the fuel tank fill assembly 12 may include several steps as suggested in FIG. 7. Before the fuel filler pipe 20 is formed, a stainless steel tube 30 is formed. To form the tube 30, a sheet of stainless steel is rolled to begin forming the tube 30 as suggested by box 110. After rolling the sheet of stainless steel, a seal of the sheet of stainless steel is laser welded to form a laser weld seam 70 as suggested by box 112. The laser weld seam 70 allows the tube 30 to be expanded since the seam 70 will not become brittle after the expansion process 116.

Typically, steel may be TIG welded at the seam to form a tube. However, TIG welding may not be suitable for the expansion process 116 to form the single-piece fuel filler pipe 20. TIG welding uses heat created from an electric arc to melt the seam and a filler metal to bond the seam together. TIG welding applies large amounts of heat to the steel such that it forms a heat affected zone in the tube, which becomes brittle after the expansion process. As a result, leaks may form in the fuel filler pipe after the expansion process.

Therefore, to form the tube 30, the rolled sheet of stainless steel is laser welded. Laser welding uses a laser beam to form a laser weld seam 70. The concentrated laser beam is focused at the seam of the stainless steel to the point of melting. The melting around the seam allows the two edges to be joined together to form the laser weld seam 70. No filler material is used for laser welding.

The laser welding does not create a heat affected zone, as it does not change the material structure at the resulting laser weld seam 70. The resulting laser welded tube 30 may be expanded with the expansion process 116 to form the single-piece fuel filler pipe 20.

Once the tube 30 is formed, the tube 30 may be end-formed as suggested by box 114. Then the tube 30 is ready to go through the 6-stage expansion process to form the filler head 32 and filler neck 34 as suggested by box 116.

The 6-stage expansion process 116 as shown in FIG. 7 includes six steps of expanding the initial diameter of the tube 30 using the associated machine 76, the die 78, and tooling 80, 82, 84, 86, 88, 90. At the onset of the expansion process 116, the tube 30 has an inner diameter equal to the first inner diameter D1.

To expand the inner diameter of the tube 30 at or near an end of the tube 30 to form the filler head 32 and filler neck 34, the method uses the ram machine 76 with different toolings 80, 82, 84, 86, 88, 90 to expand the end of the tube 30 in a cavity of the die 78. The portion of the tube 30 to be the filler head 32 and filler neck 34 is gradually expanded using the different toolings 80, 82, 84, 86, 88, 90 to form the different diameters D1, D2, D3, D4. Table 1 shown below provides the expansion percentage of the tube 30 compared to the raw diameter of the tube 30 at each of the different tooling steps.

TABLE 1
Expansion Percentage of Raw Diameter
for Compact Standard Filler Pipe

| ID | RAW | 1 | 2 | 3 | 4 | 5 | 6 |
|---|---|---|---|---|---|---|---|
| UP- | 26.8 | 38.1 | 40.6 | 43.2 | 49.4 | 50.4 | TRIM |
| PER | | (42%) | (52%) | (61%) | (84%) | (88%) | |
| LOW- | | | | | 45.7 | 45.9 | |
| ER | | | | | (70%) | (71%) | |

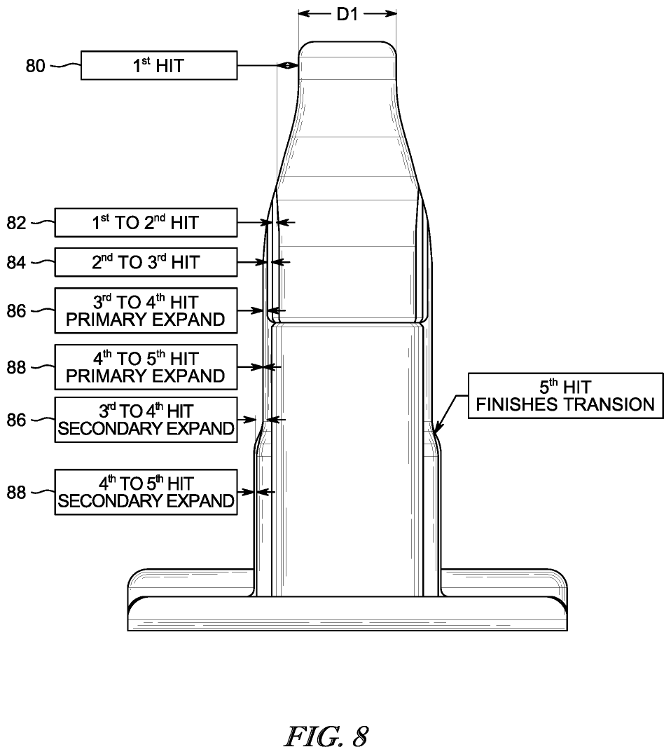

A portion of the tube 30 is gradually expanded to form the filler pipe neck 34 until the second inner diameter D2 is reached. The first tool hit 80 expands the inner diameter of the tube 30 by about, or precisely, 42% of the first inner diameter D1 of the tube 30 as shown in FIGS. 7 and 8. The first tool hit 80 forms the filler pipe neck 34 that extends from the tube 30 and begins to form the fill cup 40 of the filler head 32.

Next, the second tool hit 82 is used to further expand the filler pipe neck 34 to form the fill cup 40 of the filler head 32. The second tool hit 82 further expands the inner diameter of the portion of the tube 30 so that the inner diameter is increased by about, or precisely, 50% of the first inner diameter D1 of the tube 30 as shown in FIGS. 7 and 8.

Next, the third tool hit 84 is used to further expand the fill cup 40. The third tool hit 84 further expands the inner diameter of the portion of the tube 30 so that the inner diameter is increased by about, or precisely, 61% of the first inner diameter D1 of the tube 30 as shown in FIGS. 7 and 8.

Next, the fourth tool hit 86 is used to further expand of the fill cup 40 and to begin forming the filler head transition 44 and the closure unit mount 42. The fourth tool hit 86 further expands the inner diameter by about, or precisely, 70% of the first inner diameter D1 to the second inner diameter D2 to finish forming the fill cup 40.

In some embodiments, the portion of the tube 30 is expanded between about, or precisely, 68% and 103% of the first diameter D1 to form the fill cup 40. In other embodiments, the portion of the tube 30 is expanded between about, or precisely, 68% and 71%. In other embodiments, the portion of the tube 30 is expanded between about, or precisely, 100% and 103%.

Next, the fill cup portion 40 of the expanded tube 30 is gradually expanded to the third diameter D3 to form the closure unit mount 42. The portion of the tube 30 is gradually expanded to form the filler head transition portion 44 until the third diameter D3 is reached.

In the illustrative embodiment, the fourth tool hit 86 also begins to form the filler head transition portion 44 and the closure unit mount 42 as shown in FIGS. 7 and 8. The fourth tool hit 86 expands the inner diameter so that the inner diameter is increased by about, or precisely, 84% of the first inner diameter D1 of the tube 30.

In some embodiments, the portion of the tube 30 is further expanded between about, or precisely, 78% and 110% of the first diameter D1. In other words, the fill cup 40 is expanded between about, or precisely 2.7% and 7% of the second diameter D2. In other embodiments, the portion of the tube 30 is expanded between about, or precisely, 78%-80% of the first diameter D1, or 3%-7% of the second diameter D2. In other embodiments, the portion of the tube 30 is expanded between about, or precisely, 108%-110%, or 2.7%-4.6% of the second diameter D2.

The fifth tool hit 88 is used to smooth out the filler head transition portion 44 and expand the inner diameter to the third diameter D3 to fully form the closure unit mount 42. The fifth tool hit 86 expands the inner diameter of the portion of the tube 30 so that the inner diameter of the closure unit mount 42 is increased by about, or precisely, 88% of the first inner diameter D1 of the tube 30. In the illustrative embodiment, the fifth tool hit 86 expands the inner diameter of the fill cup 40 so that the inner diameter of the tube 30 is increased by about, or precisely, 71% of the first inner diameter D1 of the tube 30 to finish forming the fill cup 40.

Finally, the closure unit mount portion 42 of the expanded tube 30 is expanded further to form the flange 56. The sixth tool hit 90 forms the flange 56 in the illustrative embodiment. The tube 30 is expanded to form the flange 56 until the flange 56 has the fourth diameter D4.

In some embodiments, the closure unit mount 42 is expanded between about, or precisely 6% and 11.4% of the third diameter D3. In other embodiments, the closure unit mount 42 is expanded between about, or precisely, 7.2%-10.9% of the third diameter D3. In other embodiments, the closure unit mount 42 is expanded between about, or precisely, 6.6%-9.7% of the third diameter D3.

At the end of the 6-stage expansion process, the raw diameter of the portion of the tube 30 will have been expanded by about, or precisely 88% of the first inner diameter D1 of the tube 30. In the illustrative embodiment, the resulting second inner diameter D2 is about, or precisely 45.8 millimeters, the resulting third inner diameter D3 is about, or precisely 50.4 millimeters, and the resulting fourth diameter D4 is about, or precisely 54.8 millimeters.

In some embodiments, the resulting second inner diameter D2 is between about, or precisely 45-47 millimeters. In other embodiments, the resulting second inner diameter D2 is between about, or precisely 45-46 millimeters.

In some embodiments, the resulting third inner diameter D3 is between about, or precisely 48-51 millimeters. In other embodiments, the resulting third inner diameter D3 is between about, or precisely 49-50 millimeters.

In some embodiments, the resulting fourth diameter D4 is between about, or precisely 52-55 millimeters. In other embodiments, the resulting third inner diameter D3 is between about, or precisely 53-54 millimeters.

Once the single-piece fuel filler pipe 20 is formed, the fuel filler pipe 20 may be welded as suggested by box 118. The fuel filler pipe 20 may also be steam cleaned as suggested by box 120 before the closure unit 22 is installed into the inlet 26 of the fuel filler pipe 20. The fuel tank fill assembly 12 may be fully assembled as suggested by box 122 and tested as suggested by box 124. After the assembly 12 is tested, the assembly 12 may then be labeled and shipped as suggested by box 126.

To have a useful life of 150,000 miles or 15 years, fuel system may be able to withstand harsh corrosion environments. Fuel filler pipes carry fuel, so corrosion protection is may be helpful to increase the life of the part.

Because of this, stainless steel is commonly used in the industry, e.g. 304, 304L. Fuel filler pipes may have an expansion for the fuel cap restrictor or for a capless closure 22. Such an expansion may be difficult to form with stainless steel, so commonly the filler head portion (expansion portion) may be made in a separate forming operation, e.g. deep draw. The filler head portion may then be welded to the tube.

The present disclosure relates to a fuel filler pipe 20 that allows the tube 30 to be successfully expanded to be able to mount a closure unit 22, specifically, the compact or universal capless closure. Because the tube 30 may be expanded, the deep drawn filler head is not needed, reducing the cost to manufacture the fuel tank fill assembly 12. In addition, no welding of the filler head 32 is required, which saves more and eliminates a possible leak path at the weld joint.

The shape of the filler head 32 is conical and concentric with at least a portion of the filler tube 30. The filler tube 30 is first expanded to the second inner diameter D2 that provides the seal interface for the primary seal 64 (lower seal) of the capless closure unit 22. The filler head 32 has a gradual step, 44 that allows the primary seal (lower seal) of the capless to insert into its latched position with minimal axial translation. This also ensures compression force on seal 64 is radial and not axial.

The closure unit mount 42 has a larger expansion above the step 44 that is to the third inner diameter D3 that provides the seal interface for the secondary seal 66 (upper seal) of the capless closure unit 22. Finally, the filler head 32 has a flange 56 to allow the secure latching of the closure unit 22, specifically the compact and universal capless.

Another embodiment of fuel filler pipe 220 in accordance with the present disclosure is shown in FIGS. 10-12. The fuel filler pipe 220 is substantially similar to the fuel filler pipe 20 shown in FIGS. 1-9 and described herein. Accordingly, similar reference numbers in the 200 series indicate features that are common between the fuel filler pipe 20 and the fuel filler pipe 220. The description of the fuel filler pipe 20 is incorporated by reference to apply to the fuel filler pipe 220, except in instances when it conflicts with the specific description and the drawings of the fuel filler pipe 220.

The fuel filler pipe 220 is formed from stainless steel materials as a single-piece component and shaped to define a filler tube 230, a filler head 232, and a filler pipe neck 234 as shown in FIGS. 10 and 11. The filler tube 230 is configured to be coupled to the fuel tank 14 to deliver fuel to the fuel tank 14. The filler head 232 is configured to mount a closure unit that may be different from the closure unit 22 that fits the filler head 32 of the first embodiment. The filler pipe neck 234 extends from the filler tube 230 to the filler head 232 at a neck transition angle α relative to the filler tube 230.

The filler tube 230 has a first inner diameter D1, while the filler head 232 has a second inner diameter D2 as shown in FIG. 10. The first inner diameter D1 of the filler tube 230 is less than the second inner diameter D2 of the filler head 232 so as to create the venturi effect within a passageway 224 to suction the fuel toward the fuel tank 14 during refueling.

A ratio of the first inner diameter D1 of the filler tube 230 to the second inner diameter D2 of the filler head 232 may be about, or precisely, 0.59 in the illustrative embodiment. In the illustrative embodiment, the first inner diameter D1 of the filler tube 230 may be about, or precisely, 27 millimeters. The filler tube 230 may be expanded to the second inner diameter D2 about, or precisely. 69% of the first diameter D1.

The filler pipe neck 234 is shaped to define a first fillet 236 at the interface with the filler tube 230 and a second fillet 238 at the interface with the filler head 232 as shown in FIG. 11. The filler pipe neck 234 extends between the filler tube 230 and the filler head 232 at the neck transition angle α so as to follow the natural material flow.

The filler head 232 of the fuel filler pipe 220 is shaped to define a fill cup 240, a closure unit mount 242, and a filler head transition portion 244 as shown in FIGS. 10 and 11. The fill cup 240 has the second inner diameter D2 and extends from the filler pipe neck 234. The closure unit mount 242 is configured to receive the closure unit. The filler head transition portion 244 extends from the fill cup 240 to the closure unit mount 242 at a transition angle (3 relative to the fill cup 240. The closure unit mount 242 has a third inner diameter D3 that is greater than the second inner diameter D2 of the fill cup 240 as shown in FIG. 11.

A ratio of the first inner diameter D1 of the filler tube 230 to the third inner diameter D3 of the closure unit mount 242 may be about, or precisely, 0.56 in the illustrative embodiment. In other words, to form the closure unit mount 242 of the filler head 232, the filler tube 230 is further expanded to the third diameter D3 of the fill cup 240. The filler tube 230 is expanded between about, or precisely, 79% of the first diameter D1 to form the closure unit mount 242.

A ratio of the second inner diameter D2 of the fill cup 240 and the third inner diameter D3 of the closure unit mount 241 may be about, or precisely, 0.95 in the illustrative embodiment. In other words, to form the closure mount unit 242, the fill cup 240 is expanded between, or precisely 6% of the second diameter D2.

The filler head transition portion 244 is shaped to define a first fillet 250 at the interface with the fill cup 240 and a second fillet 252 at the interface with the closure unit mount 242 as shown in FIG. 11. The filler head transition portion 244 extends a length L between fill cup 240 and the closure unit mount 242. The length L between the fill cup 240 and the closure unit mount 242 may be less than the length L of the first embodiment of the fuel filler pipe 20.

The closure unit mount 242 is shaped to define a mount body 254 and a flange 256 as shown in FIGS. 10-12. The mount body 254 has the third inner diameter D3 and extends from the filler head transition portion 244. The flange 256 extends from the mount body 254.

In the illustrative embodiment, the flange 256 has a fourth diameter D4 as shown in FIG. 11. The fourth diameter D4 is greater than the third inner diameter D3 of the mount body 254.

A ratio of the first inner diameter D1 of the filler tube 30 and the fourth diameter D4 of the flange 256 may be about, or precisely, 0.51 in the illustrative embodiment. A ratio of the third inner diameter D3 of the mount body 54 and the fourth diameter D4 of the flange 256 may be about, or precisely, 0.91 in the illustrative embodiment. In other words, to form the flange 256, the mount body 254 is expanded further to the fourth diameter D4. In the illustrative embodiment, the closure unit mount 242 is expanded about, or precisely 9% of the third diameter D3.

The method of forming the fuel filler pipe 220 is similar to the embodiment of FIGS. 1-9; however, the expansion at each of the steps may be different. In the illustrative embodiment, the expansion of a portion of the tube 230 at each of the tool hits 80, 82, 84, 86, 88, 90 is less than that of the embodiment shown in FIGS. 1-9. Table 2 shown below provides the expansion percentage of the tube 230 compared to the raw or original inner diameter of the tube 230 at each of the different tooling steps.

TABLE 2
Expansion Percentage of Raw Diameter
for Compact Mini Filler Pipe

| ID | RAW | 1 | 2 | 3 | 4 | 5 | 6 |
|---|---|---|---|---|---|---|---|
| UP- | 26.8 | 33.0 | 38.1 | 40.6 | 43.2 | 48.4 | TRIM |
| PER | | (23%) | (42%) | (52%) | (61%) | (81%) | |
| LOW- | | | | | | 45.9 | |
| ER | | | | | | (71%) | |

A portion of the tube 230 at or near the end of the tube 230 is gradually expanded to form the filler pipe neck 234 until the second inner diameter D2 is reached. In the illustrative embodiment, the first tool hit expands the inner diameter of the tube 230 by about, or precisely, 23% of the first inner diameter D1 of the tube 230. The first tool hit forms the filler pipe neck 234 and begins to form the fill cup 240 of the filler head 232.

Next, the second tool hit is used to further expand the filler pipe neck 234 to form the fill cup 240 of the filler head 32. In the illustrative embodiment, the second tool hit further expands the inner diameter of the portion of the tube 230 so that the inner diameter is increased by about, or precisely, 42% of the first inner diameter D1 of the tube 230.

Next, the third tool hit is used to further expand the fill cup 240. In the illustrative embodiment, the third tool hit further expands the inner diameter of the portion of the tube 230 so that the inner diameter is increased by about, or precisely, 52% of the first inner diameter D1 of the tube 230.

Next, the fourth tool hit is used to further expand of the fill cup 240. In the illustrative embodiment, the fourth tool hit further expands the inner diameter of the portion of the tube 230 by about, or precisely, 61% of the first inner diameter D1.

Next, the fill cup portion 240 of the expanded portion of the tube 230 is fully formed so that the fill cup portion 240 has the second inner diameter D2. Additionally, the fill cup portion 240 is gradually expanded to the third diameter D3 to form the closure unit mount 242. The portion of the tube 230 is gradually expanded to form the filler head transition portion 244 until the third diameter D3 is reached.

The fifth tool hit is used to finish forming the fill cup 240, smooth out the filler head transition portion 244, and expand the inner diameter of the portion of the tube 230 to the third diameter D3 to fully form the closure unit mount 342. The fifth tool hit expands the inner diameter of the fill cup 240 so that the inner diameter is increased by about, or precisely, 71% of the first inner diameter D1 of the tube 230 to finish forming the fill cup 240. The fifth tool hit also expands the inner diameter of the portion of the tube 230 so that the inner diameter of the closure unit mount 242 is increased by about, or precisely, 81% of the first inner diameter D1 of the tube 230.

Finally, the closure unit mount portion 242 of the expanded tube 230 is expanded further to form the flange 256. The sixth tool hit forms the flange 256 in the illustrative embodiment. The tube 230 is expanded to form the flange 256 until the flange 256 has the fourth diameter D4.

At the end of the 6-stage expansion process, the raw, or first inner diameter of the tube 230 will have been expanded by about, or precisely 81% of the first inner diameter D1 of the tube 230. In the illustrative embodiment, the resulting second inner diameter D2 is about, or precisely 45.7 millimeters, the resulting third inner diameter D3 is about, or precisely 48.3 millimeters, and the resulting fourth diameter D4 is about, or precisely 52.8 millimeters. Compared to the embodiment of FIGS. 1-9, the each of the diameters D2, D3, D4 of the fuel filler pipe 220 is less than that of the fuel filler pipe 20.

In some embodiments, the resulting second inner diameter D2 is between about, or precisely 44-46 millimeters. In other embodiments, the resulting second inner diameter D2 is between about, or precisely 45-46 millimeters.

In some embodiments, the resulting third inner diameter D3 is between about, or precisely 47-49 millimeters. In other embodiments, the resulting third inner diameter D3 is between about, or precisely 48-49 millimeters.

In some embodiments, the resulting fourth diameter D4 is between about, or precisely 50-53 millimeters. In other embodiments, the resulting third inner diameter D3 is between about, or precisely 51-52 millimeters.

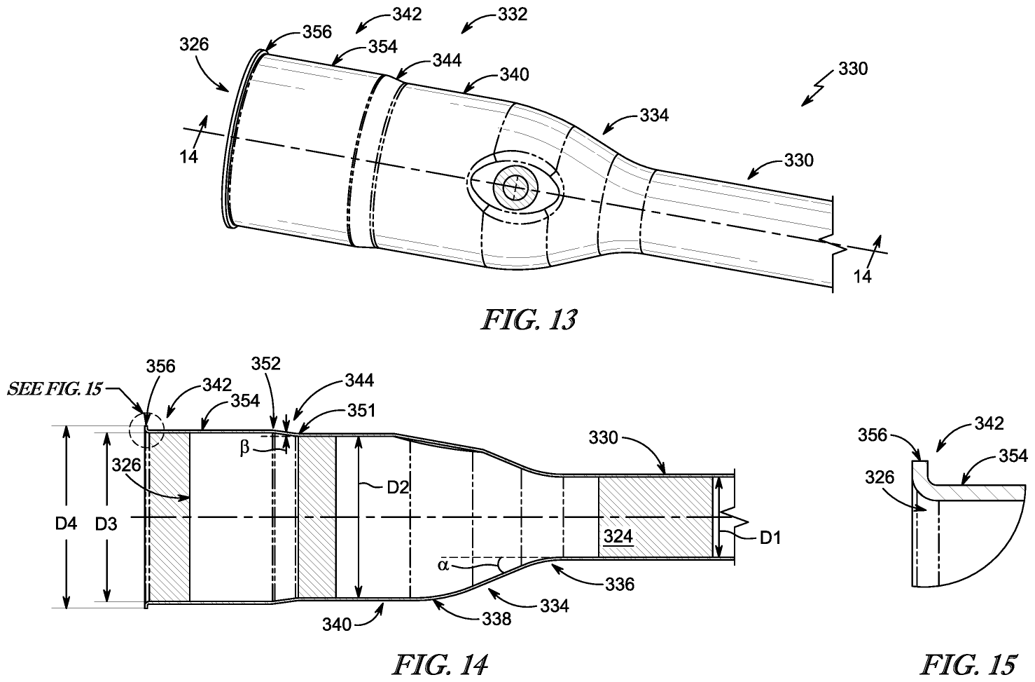

Another embodiment of fuel filler pipe 320 in accordance with the present disclosure is shown in FIGS. 13-15. The fuel filler pipe 320 is substantially similar to the fuel filler pipe 20 shown in FIGS. 1-9 and described herein. Accordingly, similar reference numbers in the 300 series indicate features that are common between the fuel filler pipe 20 and the fuel filler pipe 320. The description of the fuel filler pipe 20 is incorporated by reference to apply to the fuel filler pipe 320, except in instances when it conflicts with the specific description and the drawings of the fuel filler pipe 320.

The fuel filler pipe 320 is formed from stainless steel materials as a single-piece component and shaped to define a filler tube 330, a filler head 332, and a filler pipe neck 334 as shown in FIGS. 13 and 14. The filler tube 330 is configured to be coupled to the fuel tank 14 to deliver fuel to the fuel tank 14. The filler head 332 is configured to mount a closure unit that may be different from the closure unit 22 that fits the filler head 32 of the first embodiment. The filler pipe neck 234 extends from the filler tube 330 to the filler head 332 at a neck transition angle α relative to the filler tube 330.

The filler tube 330 has a first inner diameter D1, while the filler head 332 has a second inner diameter D2 as shown in FIG. 14. The first inner diameter D1 of the filler tube 330 is less than the second inner diameter D2 of the filler head 332 so as to create the venturi effect within a passageway 324 to suction the fuel toward the fuel tank 14 during refueling.

A ratio of the first inner diameter D1 of the filler tube 330 to the second inner diameter D2 of the filler head 332 may be about, or precisely, 0.50 in the illustrative embodiment. In the illustrative embodiment, the first inner diameter D1 of the filler tube 330 may be about, or precisely, 27 millimeters. The filler tube 330 may be expanded to the second inner diameter D2 about, or precisely. 101% of the first diameter D1.

The filler pipe neck 334 is shaped to define a first fillet 336 at the interface with the filler tube 330 and a second fillet 338 at the interface with the filler head 332 as shown in FIG. 14. The filler pipe neck 334 extends between the filler tube 330 and the filler head 332 at the neck transition angle α so as to follow the natural material flow.

The filler head 332 of the fuel filler pipe 320 is shaped to define a fill cup 340, a closure unit mount 342, and a filler head transition portion 344 as shown in FIGS. 13 and 14. The fill cup 340 has the second inner diameter D2 and extends from the filler pipe neck 334. The closure unit mount 342 is configured to receive the closure unit. The filler head transition portion 344 extends from the fill cup 340 to the closure unit mount 342 at a transition angle (3 relative to the fill cup 340. The closure unit mount 342 has a third inner diameter D3 that is greater than the second inner diameter D2 of the fill cup 340 as shown in FIG. 14.

A ratio of the first inner diameter D1 of the filler tube 330 to the third inner diameter D3 of the closure unit mount 342 may be about, or precisely, 0.48 in the illustrative embodiment. In other words, to form the closure unit mount 342 of the filler head 332, the filler tube 330 is further expanded to the third diameter D3 of the fill cup 340. The filler tube 330 is expanded between about, or precisely, 109% of the first diameter D1 to form the closure unit mount 342.

A ratio of the second inner diameter D2 of the fill cup 340 and the third inner diameter D3 of the closure unit mount 341 may be about, or precisely, 0.96 in the illustrative embodiment. In other words, to form the closure mount unit 342, the fill cup 340 is expanded between, or precisely 4% of the second diameter D2.

The filler head transition portion 344 is shaped to define a first fillet 350 at the interface with the fill cup 340 and a second fillet 352 at the interface with the closure unit mount 342 as shown in FIG. 14. The filler head transition portion 344 extends a length L between fill cup 340 and the closure unit mount 342. The length L between the fill cup 340 and the closure unit mount 342 may be less than the length L of the first embodiment of the fuel filler pipe 20.

The closure unit mount 342 is shaped to define a mount body 354 and a flange 356 as shown in FIGS. 13-15. The mount body 354 has the third inner diameter D3 and extends from the filler head transition portion 344. The flange 356 extends from the mount body 354.

In the illustrative embodiment, the flange 356 has a fourth diameter D4 as shown in FIG. 14. The fourth diameter D4 is greater than the third inner diameter D3 of the mount body 354.

A ratio of the first inner diameter D1 of the filler tube 30 and the fourth diameter D4 of the flange 356 may be about, or precisely, 0.44 in the illustrative embodiment. A ratio of the third inner diameter D3 of the mount body 54 and the fourth diameter D4 of the flange 356 may be about, or precisely, 0.92 in the illustrative embodiment. In other words, to form the flange 356, the mount body 354 is expanded further to the fourth diameter D4. In the illustrative embodiment, the closure unit mount 342 is expanded about, or precisely 8% of the third diameter D3.

The method of forming the fuel filler pipe 320 is similar to the embodiment of FIGS. 1-9; however, the expansion at each of the steps may be different. In the illustrative embodiment, the expansion of the tube 330 at each of the tool hits 80, 82, 84, 86, 88, 90 is greater than that of the embodiment shown in FIGS. 1-9. Table 3 shown below provides the expansion percentage of the tube 330 compared to the raw or original inner diameter of the tube 330 at each of the different tooling steps.

TABLE 3
Expansion Percentage of Raw Diameter
for Universal Standard Filler Pipe

| ID | RAW | 1 | 2 | 3 | 4 | 5 | 6 |
|---|---|---|---|---|---|---|---|
| UP- | 26.8 | 38.1 | 46.99 | 49.53 | 52.07 | 56.44 | TRIM |
| PER | | (42%) | (75%) | (85%) | (94%) | (111%) | |
| LOW- | | | | | | 54.43 | |
| ER | | | | | | (103%) | |

A portion of the tube 330 at or near an end of the tube 330 is gradually expanded to form the filler pipe neck 334 until the second inner diameter D2 is reached. In the illustrative embodiment, the first tool hit expands the inner diameter of the tube 330 by about, or precisely, 42% of the first inner diameter D1 of the tube 330. The first tool hit forms the filler pipe neck 334 and begins to form the fill cup 340 of the filler head 332.

Next, the second tool hit is used to further expand the filler pipe neck 234 to form the fill cup 240 of the filler head 32. In the illustrative embodiment, the second tool hit further expands the inner diameter of the portion of the tube 330 so that the inner diameter is increased by about, or precisely, 75% of the first inner diameter D1 of the tube 330.

Next, the third tool hit is used to further expand the fill cup 240. In the illustrative embodiment, the third tool hit further expands the inner diameter of the portion of the tube 330 so that the inner diameter is increased by about, or precisely, 85% of the first inner diameter D1 of the tube 330.

Next, the fourth tool hit is used to further expand the fill cup 240. In the illustrative embodiment, the fourth tool hit further expands the inner diameter of the portion of the tube 330 by about, or precisely. 94% of the first inner diameter D1.

Next, the fill cup portion 340 of the expanded portion of the tube 330 is fully formed so that the fill cup portion 340 has the second inner diameter D2. Additionally, the fill cup portion 340 is gradually expanded to the third diameter D3 to form the closure unit mount 342. The portion of the tube 330 is gradually expanded to form the filler head transition portion 344 until the third diameter D3 is reached.

The fifth tool hit is used to finish forming the fill cup 340, smooth out the filler head transition portion 344, and expand the inner diameter of the tube 330 to the third diameter D3 to fully form the closure unit mount 342. The fifth tool hit expands the inner diameter of the fill cup 340 so that the inner diameter is increased by about, or precisely, 103% of the first inner diameter D1 of the tube 330 to finish forming the fill cup 340. The fifth tool hit also expands the inner diameter of the portion of the tube 330 so that the inner diameter of the closure unit mount 342 is increased by about, or precisely, 111% of the first inner diameter D1 of the tube 330.

Finally, the closure unit mount portion 342 of the expanded tube 330 is expanded further to form the flange 356. The sixth tool hit forms the flange 356 in the illustrative embodiment. The tube 330 is expanded to form the flange 356 until the flange 356 has the fourth diameter D4.

At the end of the 6-stage expansion process, the raw, or first inner diameter of the tube 330 will have been expanded by about, or precisely 110% of the first inner diameter D1 of the tube 230. In the illustrative embodiment, the second inner diameter D2 is about, or precisely 54.4 millimeters, the third inner diameter D3 is about, or precisely 56.4 millimeters, and the fourth diameter D4 is about, or precisely 61 millimeters. Compared to the embodiment of FIGS. 1-9, the each of the diameters D2, D3, D4 of the fuel filler pipe 320 is greater than that of the fuel filler pipe 20.

In some embodiments, the resulting second inner diameter D2 is between about, or precisely 52-55 millimeters. In other embodiments, the resulting second inner diameter D2 is between about, or precisely 54-55 millimeters.

In some embodiments, the resulting third inner diameter D3 is between about, or precisely 56-58 millimeters. In other embodiments, the resulting third inner diameter D3 is between about, or precisely 56-57 millimeters.

In some embodiments, the resulting fourth diameter D4 is between about, or precisely 60-62 millimeters. In other embodiments, the resulting third inner diameter D3 is between about, or precisely 60-61 millimeters.

In the illustrative embodiment, the stainless steel material of the fuel filler pipe 220, 320 may be the same as the fuel filler pipe 20 of FIGS. 1-9. The stainless steel material of the fuel filler pipe 220, 320 may be 304 stainless steel, 304L stainless steel, 436 stainless steel, and/or 436L stainless steel. The 304 stainless steel has a carbon content of about, or precisely 0.08%. The 304L stainless steel has a carbon content of about, or precisely 0.03%. The 436 stainless steel has a carbon content of about, or precisely 0.12%. The 304L stainless steel has a carbon content of about, or precisely 0.03%. Therefore the carbon content of the stainless steel materials that form the fuel filler pipe 220, 320 may be between about, or precisely 0.03% and 0.12%.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

The following numbered clauses include embodiments that are contemplated and non-limiting:

Clause 1. A fuel tank fill assembly adapted to conduct fuel from a fuel-dispensing nozzle to a fuel tank, the assembly comprising

a single-piece fuel filler pipe comprising stainless steel materials, the single-piece fuel filler pipe shaped to define a passageway configured to carry fuel to the fuel tank, and

a closure unit mounted to the single-piece fuel filler pipe and configured to selectively close an inlet of the passageway.

Clause 2. The fuel tank fill assembly of clause 1, any other suitable clause, or any combination of clauses, wherein the single-piece fuel filler pipe is shaped to define a filler tube configured to be coupled to the fuel tank to deliver fuel to the fuel tank, a filler head configured to mount the closure unit and sized to receive the fuel-dispensing nozzle, and a filler pipe neck that extends from the filler tube to the filler head at a neck transition angle relative to the filler tube.

Clause 3. The fuel tank fill assembly of clause 2, any other suitable clause, or any combination of clauses, wherein the filler tube has a first inner diameter that is less than a second inner diameter of the filler head.

Clause 4. The fuel tank fill assembly of clause 3, any other suitable clause, or any combination of clauses, wherein the filler head of the fuel filler pipe is shaped to define a fill cup having the second inner diameter that extends from the filler pipe neck, a closure unit mount configured to receive the closure unit, and a filler head transition portion that extends from the fill cup to the closure unit mount at a transition angle relative to the fill cup.

Clause 5. The fuel tank fill assembly of clause 4, any other suitable clause, or any combination of clauses, wherein the closure unit mount has a third inner diameter that is greater than the second inner diameter of the fill cup.

Clause 6. The fuel tank fill assembly of clause 5, any other suitable clause, or any combination of clauses, wherein the transition angle of the filler head transition portion is between about 5 degrees and 9 degrees.

Clause 7. The fuel tank fill assembly of clause 5, any other suitable clause, or any combination of clauses, wherein a ratio of the first inner diameter of the filler tube and the third diameter of the closure unit mount is between 0.47 and 0.57.

Clause 8. The fuel tank fill assembly of clause 5, any other suitable clause, or any combination of clauses, wherein the closure unit mount is shaped to define a mount body having the third inner diameter that extends from the filler head transition portion and a flange that extends from the mount body and is configured to allow the secure latching of the closure unit.

Clause 9. The fuel tank fill assembly of clause 8, any other suitable clause, or any combination of clauses, wherein the flange has a fourth diameter that is greater than the third inner diameter of the mount body.

Clause 10. The fuel tank fill assembly of clause 9, any other suitable clause, or any combination of clauses, wherein the neck transition angle of the filler pipe neck is between about 10 degrees and 15 degrees.

Clause 11. The fuel tank fill assembly of clause 3, any other suitable clause, or any combination of clauses, wherein a ratio of the first inner diameter of the filler tube and the second inner diameter of the filler head is between 0.49 and 0.60.

Clause 12. The fuel tank fill assembly of clause 11, any other suitable clause, or any combination of clauses, wherein the first inner diameter of the filler tube is about 27 millimeters.

Clause 13. The fuel tank fill assembly of clause 3, any other suitable clause, or any combination of clauses, wherein the stainless steel materials has a carbon content between about 0.03% and about 0.12%.

Clause 14. The fuel tank fill assembly of clause 3, any other suitable clause, or any combination of clauses, wherein the single-piece fuel filler pipe has a laser weld seam.

Clause 15. A fuel storage system adapted to receive and store fuel for use in a vehicle, the system comprising

a fuel tank configured to store fuel for later use by an engine included in the vehicle, and

the fuel tank fill assembly of any one of clauses 1-4.

Clause 16. A method comprising

providing a tube of stainless steel, and

expanding the tube of stainless steel to form the single-piece fuel filler pipe included in the fuel tank fill assembly of any one of clauses 1-14.

Clause 17. A fuel tank fill assembly characterized in that it comprises

a single-piece fuel filler pipe comprising stainless steel materials, the single-piece fuel filler pipe shaped to define a passageway, and

a closure unit mounted to the single-piece fuel filler pipe and configured to selectively close an inlet of the passageway.

Clause 18. The fuel tank fill assembly of clause 17, any other suitable clause, or any combination of clauses, characterized in that the single-piece fuel filler pipe is shaped to define a filler tube, a filler head configured to mount the closure unit and sized to receive a fuel-dispensing nozzle, and a filler pipe neck that extends from the filler tube to the filler head at a neck transition angle relative to the filler tube, the filler tube having a first inner diameter that is less than a second inner diameter of the filler head.

Clause 19. The fuel tank fill assembly of clause 18, any other suitable clause, or any combination of clauses, characterized in that the filler head of the fuel filler pipe is shaped to define a fill cup having the second inner diameter that extends from the filler pipe neck, a closure unit mount configured to receive the closure unit, and a filler head transition portion that extends from the fill cup to the closure unit mount at a transition angle relative to the fill cup, the closure unit mount having a third inner diameter that is greater than the second inner diameter of the fill cup.

Clause 20. The fuel tank fill assembly of clause 19, any other suitable clause, or any combination of clauses, characterized in that the closure unit mount is shaped to define a mount body having the third inner diameter that extends from the filler head transition portion and a flange that extends from the mount body, the flange having a fourth diameter that is greater than the third inner diameter of the mount body.

Clause 21. The fuel tank fill assembly of clause 20, any other suitable clause, or any combination of clauses, characterized in that the transition angle of the filler head transition portion is between about 5 degrees and 9 degrees.

Clause 22. The fuel tank fill assembly of clause 21, any other suitable clause, or any combination of clauses, characterized in that a ratio of the first inner diameter of the filler tube and the third diameter of the closure unit mount is between 0.47 and 0.57.

Clause 23. The fuel tank fill assembly of clause 22, any other suitable clause, or any combination of clauses, characterized in that the neck transition angle of the filler pipe neck is between about 10 degrees and 15 degrees.

Clause 24. The fuel tank fill assembly of clause 23, any other suitable clause, or any combination of clauses, characterized in that a ratio of the first inner diameter of the filler tube and the second inner diameter of the filler head is between 0.49 and 0.60.

Clause 25. The fuel tank fill assembly of clause 24, any other suitable clause, or any combination of clauses, characterized in that the first inner diameter of the filler tube is about 27 millimeters.

Clause 26. The fuel tank fill assembly of clause 25, any other suitable clause, or any combination of clauses, characterized in that the stainless steel materials has a carbon content between about 0.03% and about 0.12%.

Clause 27. The fuel tank fill assembly of clause 26, any other suitable clause, or any combination of clauses, characterized in that the single-piece fuel filler pipe has a laser weld seam.

1. A fuel tank fill assembly adapted to conduct fuel from a fuel-dispensing nozzle to a fuel tank, the assembly comprising
a single-piece fuel filler pipe comprising stainless steel materials, the single-piece fuel filler pipe shaped to define a passageway configured to carry fuel to the fuel tank, and
a closure unit mounted to the single-piece fuel filler pipe and configured to selectively close an inlet of the passageway,
wherein the single-piece fuel filler pipe is shaped to define a filler tube configured to be coupled to the fuel tank to deliver fuel to the fuel tank, a filler head configured to mount the closure unit and sized to receive the fuel-dispensing nozzle, and a filler pipe neck that extends from the filler tube to the filler head at a neck transition angle relative to the filler tube, the filler tube having a first inner diameter that is less than a second inner diameter of the filler head.

2. The assembly of claim 1, wherein the filler head of the fuel filler pipe is shaped to define a fill cup having the second inner diameter that extends from the filler pipe neck, a closure unit mount configured to receive the closure unit, and a filler head transition portion that extends from the fill cup to the closure unit mount at a transition angle relative to the fill cup, the closure unit mount having a third inner diameter that is greater than the second inner diameter of the fill cup.

3. The assembly of claim 2, wherein the transition angle of the filler head transition portion is between about 5 degrees and 9 degrees.

4. The assembly of claim 2, wherein a ratio of the first inner diameter of the filler tube and the third diameter of the closure unit mount is between 0.47 and 0.57.

5. The assembly of claim 2, wherein the closure unit mount is shaped to define a mount body having the third inner diameter that extends from the filler head transition portion and a flange that extends from the mount body and is configured to allow the secure latching of the closure unit, the flange having a fourth diameter that is greater than the third inner diameter of the mount body.

6. The assembly of claim 1, wherein the neck transition angle of the filler pipe neck is between about 10 degrees and 15 degrees.

7. The assembly of claim 1, wherein a ratio of the first inner diameter of the filler tube and the second inner diameter of the filler head is between 0.49 and 0.60.

8. The assembly of claim 7, wherein the first inner diameter of the filler tube is about 27 millimeters.

9. The assembly of claim 1, wherein the stainless steel materials has a carbon content between about 0.03% and about 0.12%.

10. The assembly of claim 1, wherein the single-piece fuel filler pipe has a laser weld seam.

11. A fuel tank fill assembly characterized in that it comprises
a single-piece fuel filler pipe comprising stainless steel materials with a carbon content between about 0.03% and about 0.12%, the single-piece fuel filler pipe having a laser weld seam and being shaped to define a passageway, and
a capless closure unit mounted to the single-piece fuel filler pipe and configured to selectively close an inlet of the passageway,
wherein the single-piece fuel filler pipe is shaped to define a filler tube, a filler head configured to mount the cap less closure unit and sized to receive a fuel-dispensing nozzle, and a filler pipe neck that extends from the filler tube to the filler head at a neck transition angle relative to the filler tube, the filler tube having a first inner diameter that is less than a second inner diameter of the filler head.

12. The fuel tank fill assembly of claim 11, wherein the filler head of the fuel filler pipe is shaped to define a fill cup having the second inner diameter that extends from the filler pipe neck, a closure unit mount configured to receive the closure unit, and a filler head transition portion that extends from the fill cup to the closure unit mount at a transition angle relative to the fill cup, the closure unit mount having a third inner diameter that is greater than the second inner diameter of the fill cup.

13. The fuel tank fill assembly of claim 11, wherein the closure unit mount is shaped to define a mount body having the third inner diameter that extends from the filler head transition portion and a flange that extends from the mount body, the flange having a fourth diameter that is greater than the third inner diameter of the mount body.

14. The fuel tank fill assembly of claim 13, wherein the transition angle of the filler head transition portion is between about 5 degrees and 9 degrees.

15. The fuel tank fill assembly of claim 12, wherein a ratio of the first inner diameter of the filler tube and the third diameter of the closure unit mount is between 0.47 and 0.57.

16. The fuel tank fill assembly of claim 12, wherein the neck transition angle of the filler pipe neck is between about 10 degrees and 15 degrees.

17. The fuel tank fill assembly of claim 12, wherein a ratio of the first inner diameter of the filler tube and the second inner diameter of the filler head is between 0.49 and 0.60.

18. The fuel tank fill assembly of claim 12, wherein the first inner diameter of the filler tube is about 27 millimeters.

19. (canceled)

20. (canceled)
